(19) United States
(12) Patent Application Publication
(10) Pub. No.: US 2026/0257521 A1
(43) Pub. Date: Sep. 3, 2026

(54) Method For Automatically Calibrating The Power Of An Activation Signal Of At Least One Sensor And Device For Implementing Said Method

(71) Applicant: ATEQ, Les Clayes Sous Bois (FR)

(72) Inventor: Guillaume Ouvry, Les Clayes-sous-Bois (FR)

(21) Appl. No.: 19/126,023

(22) PCT Filed: Oct. 26, 2023
(86) PCT No.: PCT/EP2023/079887

§ 371 Date: Apr. 30, 2025

(30) Foreign Application Priority Data
Nov. 8, 2022 (FR) FR2211586

(51) Int. Cl. B60C 23/04

(52) U.S. Cl. CPC B60C 23/0471; B60C 23/0479

(57) ABSTRACT

The invention relates to a method (100, 100′) for automatically calibrating the power (Pi) of an activation signal (Si) of at least one pressure sensor for a tyre pressure monitoring system of a motor vehicle (5), said sensor having an identification number (Id). The method includes determination (Sdet) of the maximum transmission power Pmax of the non-activation signal of said sensor and of the minimum transmission power Pmin of the activation signal of said sensor. The method includes storage (Smem) in memory of said maximum transmission power Pmax and minimum transmission power Pmin, when a difference δ between said powers Pmax and Pmin attains a value equal to or less than a predetermined value δ₀.

### CROSS-REFERENCE TO RELATED APPLICATIONS

This application is filed pursuant to 35 U.S.C. § 371 claiming priority benefit to PCT/EP2023/079887 filed Oct. 26, 2023, which claims priority benefit to France patent application number FR2211586 filed Nov. 8, 2022, the contents of both applications are incorporated herein by reference in the entirety for all purposes.

### FIELD OF INVENTION

The present invention relates to the field of sensors, in particular pressure sensors, in the automotive sector, and to how to activate such sensors and communicate with them. The invention relates more particularly to a method for automatically calibrating the power of an activation signal of said sensors, and to activation devices allowing the implementation of said method.

### BACKGROUND

The present invention applies advantageously to pressure sensors disposed (housed) or intended to be housed in motor vehicle tyres (or tires) (for example at the wheel rim and/or the tube valve). These pressure sensors are generally paired with the motor vehicle on-board computer to which said sensors transmit data (for example relating to the pressure and/or temperature level of the tyre).

The sensor-on-board computer assembly is thus known as a ‘Tyre Pressure Monitoring System’ (TPMS).

Each pressure sensor is conventionally equipped with a transmitter, for example a radiofrequency transmitter, to allow data transmission to the on-board computer. The on-board computer receiving the data from the sensors can thus warn the vehicle user if one of the tyres has punctured or if the tyre is currently deflating, which may impact the operation or performance of the vehicle.

However, the pressure sensor disposed inside a tyre is not usually removable, thus changing a wheel involves changing the sensor, the new sensor is then not directly detected by the vehicle on-board computer.

It is indeed necessary, when changing tyres, to pair (or link by radio connection) the sensors housed in the new tyres with the vehicle on-board computer. This pairing (or establishment of a radio connection) is performed by means of a dedicated activation device (generally referred to using the term ‘TPMS tool’), said device being configured to activate the sensors, retrieve and save the relevant data emitted by the sensor, such as the sensor identifier, and transmit them to the on-board computer, so that the latter detects and locates the sensors housed in the newly fitted tyres and can pick up their signals, in order to warn the user in the event of the detection of a pressure drop in one of said tyres.

Sensor activation devices can also be used in an industrial context, i.e. in manufacturing plants: of sensors, of tyres when said sensors are fitted therein, or of motor vehicles equipped with such tyres.

In an industrial context, it is therefore necessary to activate the sensors to test them, identify them (for example for quality monitoring), configure them and/or pair them with a vehicle on-board computer.

However, plant production lines are frequently very close to each other, and an activation signal emitted by an adapted activation device may result in the activation of a plurality of sensors, it is therefore necessary to calibrate the transmission power of such an activation device to avoid reactivating undesired sensors.

For example, in a plant, the vehicle tyres or wheels may:
move along a conveyor belt, the tyres are then close enough to each other for the activation signal emitted by the activation device to trigger the activation of the sensors disposed inside the tyres adjacent to the tyre tested;
be mounted on a vehicle, the wheels are therefore relatively close to each other, and there is a risk of activation of several sensors disposed inside the different wheels of the vehicle, the risk being especially great if the vehicle, such as a truck, comprises dual wheels.

Moreover, the activation signals emitted by said activation devices are continuous or modulated electromagnetic signals, the frequency whereof is generally 125 kHz. It is a c to find a balance between a transmission power value ensuring sensor activation and minimizing the exposure for operators working in the vicinity of said activation devices.

Furthermore, during the installation of an activation device in an industrial setting, it is necessary to call out a specialist operator to perform settings of said device. The efficiency and propagation of an activation signal are closely dependent on the environment (obstacles, echoes, etc.) wherein the activation device is set up. Therefore, it is necessary to set the activation device so that the power of the signal received by the sensor is sufficient to activate the desired sensors, for example the sensors located at a determined distance on a production line, while limiting the exposure of the operators to said activation signals.

### SUMMARY

The aim of the invention is thus that of solving at least one of the problems described hereinabove and is thus a novel method for automatically calibrating the power of an activation signal of at least one sensor, in particular a pressure sensor for a motor vehicle tyre pressure monitoring system (TPMS), said sensor having an identification number and comprising at least one data transmission and receiving module, characterised in that said method comprises a:
determination of the maximum transmission power Pmax of the non-activation signal of said sensor and of the minimum transmission power Pmin of the activation signal of said sensor;
storage in memory of said maximum transmission power Pmax and minimum transmission power Pmin, when a difference δ between said powers Pmax and Pmin attains a value equal to or less than a predetermined value 80.

Thus, any activation signal emitted with a power less than or equal to the transmission power Pmax activate said sensor. Whereas any activation signal emitted with a transmission power strictly greater than the transmission power Pmin activate the sensor.

According to one possible feature, the determination of the maximum power Pmax and minimum power Pmin is stopped when the difference & between said powers Pmax and Pmin attains a value equal to or less than a value do.

According to another possible feature, the determination of said powers Pmax and Pmin is performed by means of a dichotomous variation of the power of the activation signal. Dichotomous variation means varying, by means of several iterations, the activation signal power to determine a framing of the optimal power value for activating one or more sensors under nominal operating conditions.

According to another possible feature, the activation signal emitted has a power Pi which corresponds to the arithmetic mean of the maximum power Pmax and the minimum power Pmin.

This means that the transmission power Pi of the activation signal, during the determination of the maximum and minimum powers, corresponds to 2 Pₘᵢₙ+Pₘₐₓ /2, where Pmin and Pmax are transmission power values previously stored in memory since the maximum and minimum transmission powers vary according to the result of the previously emitted signal (and therefore of the power values previously stored in memory).

According to another possible feature, the determination of said powers Pmax and Pmin is performed by the detection or non-detection of at least one response signal from said at least one sensor (i.e. emitted by said sensor) according to the activation signal previously emitted, for example by said activation device, at a power Pᵢ.

According to another possible feature, if a response signal is received from said at least one sensor then the power Pi of the activation signal having activated said sensor is identified with the minimum power Pmin (or minimum transmission power of the activation signal for which the signal activates said sensor).

According to another possible feature, if a response signal is not received from said at least one sensor then the power Pi of the activation signal having activated said sensor is identified with the maximum power Pmax (or maximum power for which the signal does not activate said sensor).

A response signal is considered not to have been received after a predetermined time TR, said time TR being for example greater than 5 seconds, and preferably greater than 10 seconds. The predetermined time TR is generally dependent on the type of sensor and the environment wherein the activation and response signals will be propagated.

According to another possible feature, there is a latency TL between each activation signal transmission iteration during the method according to the invention.

Indeed, with no latency TL, there is a risk of detecting the activation of the sensor by an activation signal from a previous step or iteration. The previous activation at the power Pi-1 can thus be interpreted as an activation at the power Pi, thus falsifying all the results. Advantageously, the latency is configurable and depends on the type of sensor and the environment wherein the sensor is located, this latency is for example set between 0.5 and 1.5 sec, and preferably substantially equal to 1 second.

According to another possible feature, there is an initialization of said method, initialization during which the initial values of the maximum power Pmax of the non-activation signal, the minimum power Pmin of the activation signal and/or the difference 80 between said maximum and minimum powers Pmax and Pmin are predetermined.

It will be noted that the initial values of the maximum power Pmax, the minimum power Pmin, and the difference of the powers do can also be default values, for example, the maximum transmission power can correspond to the maximum power at which the activation device is capable of emitting an activation signal, the minimum transmission power can correspond to the minimum power at which the activation device is capable of emitting an activation signal, whereas the difference of the power do is equal to 5% (i.e. the relative difference between powers at which the activation device is capable of emitting a minimum and maximum signal is equal to 5%).

According to another possible feature, there is prior identification of said sensors by transmission of an activation signal at a determined power, for example the maximum transmission power at which the activation device is capable of emitting a signal.

According to another possible feature, the identification number of each of the sensors having emitted a signal in response to said identification activation signal is stored in memory.

Thus, within the scope of the calibration of several sensors at the same time, for example in the case of dual wheels, it is necessary to calibrate the power of the activation signal for each of the sensors therefore for sensors located at different spatial positions. For this, it can be advantageous to associate a position with each sensor identifier, and determine whether the sensor has been activated or not according to whether a signal has been received from the sensor or not (following the transmission of an activation signal by the activation device).

According to another possible feature, there is association of a sensor (and its identifier), with a position, determined for example according to the (reception) power of the response signal following an activation signal.

According to another possible feature, there is prior manual storage in memory of the identification number of each of the sensors.

The invention also relates to a device for activating at least one sensor, in particular pressure sensors for a motor vehicle tyre pressure monitoring system, said device comprising:
at least one sensor activation module;
a module for receiving signals from the sensors;
an electronic entity configured to store and/or process information carried by the signals emitted by said sensors;
a module for communicating with a remote electronic entity, such as a motor vehicle on-board computer, in order to transmit information carried by the signals received; characterised in that said device is configured, on one hand, to determine the maximum transmission power Pmax of the non-activation signal of said at least one sensor and the minimum transmission power Pmin of the signal resulting in the activation of said at least one sensor, and, on the other, to stop the determination of said maximum power Pmax and minimum power Pmin when the difference δ between said powers Pmax and Pmin attains a value equal to or less than a predetermined value 80.

According to another possible feature, said sensors are pressure and/or temperature sensors housed in the motor vehicle tyres.

### BRIEF DESCRIPTION OF THE DRAWINGS

The invention will be better understood, and other aims, details, features and advantages thereof will become more apparent during the following description of particular embodiments of the invention, given purely by way of non-limiting example, with reference to the appended drawings, wherein:

FIG. 1, referenced FIG. 1], is a schematic representation illustrating a device for activating at least one sensor according to the invention;

FIG. 2, referenced FIG. 2, is an enlarged and partial cutaway view of the device of FIG. 1;

FIG. 3, referenced FIG. 3 is a schematic representation of a second embodiment of the activation device according to the invention;

FIG. 4, referenced FIG. 4, is a flow chart of the automatic power calibration method of an activation signal of at least one sensor according to the invention; and

FIG. 5, referenced FIG. 5, is a flow chart of an alternative embodiment of the method of FIG. 4.

### DETAILED DESCRIPTION

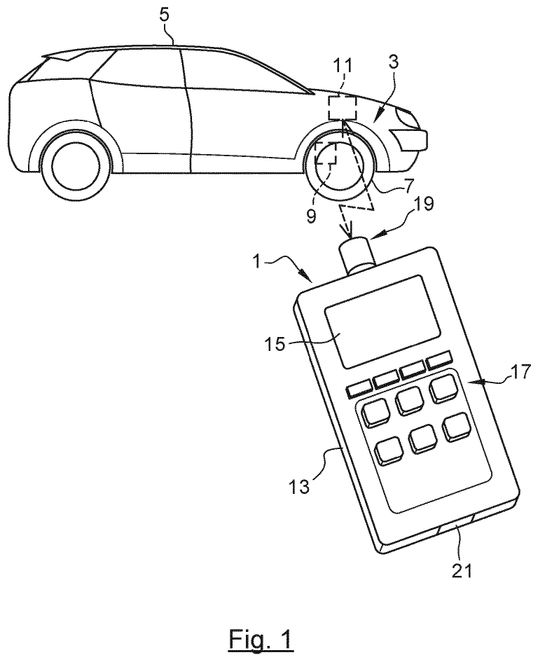

FIG. 1 is a very schematic representation of a device 1 for activating sensors 9, more particularly in the present example of a learning device for a tyre pressure monitoring system 3 (TPMS) of a motor vehicle 5 (where said device 1 can also be referred to as ‘valve activator’ or ‘valve forcer’).

The motor vehicle 5, on one hand, is equipped with tyres 7 (or tires) wherein the sensors 9, such as pressure sensors, are housed, and, on the other, comprises an on-board computer 11 (also called electronic control unit and generally referred to as the acronym ‘ECU’).

The device 1 comprises a unit 13, for example made of plastic, a display device 15, a keypad 17 and an antenna 19 for emitting a sensor activation signal, as well as an OBD socket 21. Said OBD socket 21 is configured to make it possible for example to connect the device 1 to the on-board computer 11 of a vehicle, particularly by means of an OBD cable or using a wireless (for example BLUETOOTH) dongle.

FIG. 2, for its part, is a schematic, enlarged and partial cutaway view of the activation device 1 of FIG. 1.

Said device 1 thus comprises:
at least one sensor activation module 31, such as means or modules for generating sensor activation signals (continuous and/or modulated), said activation module 31 particularly comprising the antenna 19 which makes it possible to radiate said signals generated to the sensors 9;
a module 33 for receiving signals from the sensors, generally comprising another antenna housed in the unit 13 and configured for example to pick up signals in a frequency band between 300 and 500 MHz (the sensor emitting a signal in this frequency band after having been activated by said activation module 31);
an electronic entity 35 configured to store and/or process information carried by the signals emitted by said sensors 9 (and received via the receiving module 33);
a module 37 for communicating with a motor vehicle on-board computer 11 to transmit information from at least one of said sensors 9, information received via signals from said sensors 9.

The communication module 37 is for example an OBD module which comprises an OBD communication management circuit 38 and the OBD socket 21 previously mentioned. It will be noted that the management circuit 38 can also be integrated in the electronic entity 35. Furthermore, the device 1 also comprises a battery 41 configured to power its different elements (and electronic components).

Moreover, it will be noted that said activation signals (emitted by the activation devices) are continuous or modulated electromagnetic signals, emitted by the activation module 31, which have for example a frequency of 125 kHz.

As illustrated in FIG. 1 and FIG. 2, the device 1 for activating at least one of the sensors 9 is a portable device (in particular capable of being hand-operated by an operator), but such a device 1 can also be in the form of a fixed, or transportable, device, intended to be disposed in a plant, in particular next to a production line, a garage, or on the premises of a vehicle fleet manager, etc.

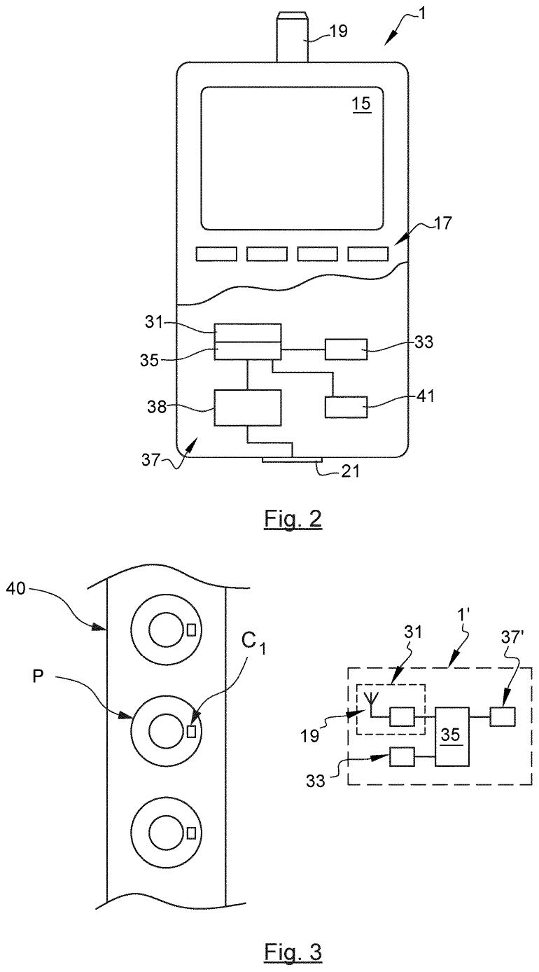

Unlike the device 1 of FIG. 1, the device 1′ for activating at least one of the sensors 9 (or sensor C1 described below) illustrated in FIG. 3 is a device intended to be positioned at a fixed location, whereas the sensors 9 to be activated are generally at a determined distance, for example on a production line 40 comprising a conveyor belt on which at least one tyre P equipped with a sensor C1 is disposed. In one example, the device 1′ can thus comprise all of the elements previously mentioned for the device 1 of FIGS. 1 and 2.

However, unlike the device 1 of FIGS. 1 and 2, said device 1′ intended for industrial applications does not generally comprise a screen, keypad, or OBD communication module, etc. Programming and dialogue with said device 1′ can be performed using a third-party electronic device connecting thereto, for example via a communication module 37′ of the device 1′.

FIG. 3, for its part, is a very schematic representation of the device 1′ for activating sensors 9 or C1 intended for an industrial setting.

The devices 1 or 1′ are configured to emit an activation signal, for example, towards at least one sensor 9 or C1, optionally housed in a tyre 7 or P. The sensor 9 or C1, when it is activated by the activation signal, emits one or more response signals in return.

Said at least one sensor 9 or C1, here a pressure sensor for a motor vehicle type tire pressure monitoring system for example, comprises at least one data transmission and receiving module, as well as an identification number.

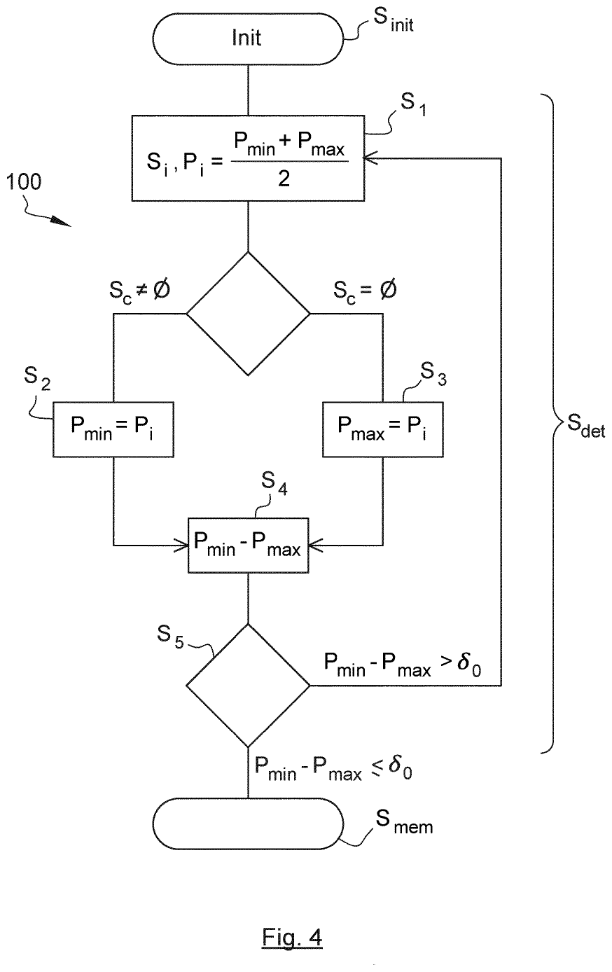

Regardless of the application, it can be advantageous to calibrate the power of the activation signal emitted by said device 1, 1′, in order to limit the exposure of the operator to electromagnetic waves and optimize the electrical power consumption of said device 1, 1′. For this, the device 1, 1′ is configured to execute a method 100 for automatically calibrating the transmission power of an activation signal of at least one sensor 9 or C1. In one example, said method 100, more particularly illustrated in FIG. 4 comprises:
a determination Sdet of a maximum power Pmax of the non-activation signal of said sensor and of a minimum power Pmin of the activation signal of said sensor;
a storage Smem in memory of said maximum power Pmax and minimum power Pmin, when a difference δ between said powers Pmax and Pmin attains a value equal to or less than a predetermined value do (for example a relative difference less than or equal to 5%).

Thus when the difference & which is equal to Pmin−Pmax≤δ₀, then the values of said maximum power Pmax and minimum power Pmin are saved in a memory, for example a random access or read only memory of the electronic entity 35, so that the value of the minimum power Pmin is used under the nominal conditions of use of the activation device 1 or 1′.

Said method 100 also comprises a preliminary initialization step Sinit, during which step the initial values of the maximum power Pmax of the non-activation signal, the minimum power Pmin of the activation signal and the difference do between said maximum and minimum powers Pmax and Pmin are predetermined and/or entered manually.

The determination of the maximum power Pmax and minimum power Pmin is stopped when the difference δ between said powers Pmax and Pmin attains a value equal to or less than the value of the difference δ₀.

It will be noted that the smaller the difference δ, the longer the method according to the invention. Moreover, the closer the location of the sensor for which the minimum activation power is to be determined to other sensors, the smaller the value of the difference δ needs to be in order to avoid activation of the nearby sensors.

More particularly, the determination Sdet of the maximum power Pmax and minimum power Pmin comprises several sub-steps which can iterate until the difference δ is less than or equal to δ₀.

Once the initial values of the parameters Pmin, Pmax and do are set, a sensor activation signal Si is emitted having a power Pi corresponding to the arithmetic mean of the values of the maximum power Pmax and the minimum power Pmin, i.e. here

$${P}_{i} = \frac{{P}_{min} + {P}_{max}}{2} .$$

For a predetermined time after the transmission of the activation signal Si, there is detection or non-detection of a response signalSc from at least one sensor (response signal emitted in response to the activation signal Si emitted). A response signal can for example be considered not to have been received after a predetermined time TR, said time TR being for example greater than 5 seconds, and preferably between 5 and 10 seconds.

Thus, if the device 1, 1′ detects the reception of the response signal Sc from the at least one sensor, there is a step S2 of updating the power value Pmin, the value of the power Pi of the previously emitted activation signal then becomes the new minimum power value Pmin and the value of the parameter Pmin is modified for the next transmission of an activation signal Si intended for the sensor 9.

Whereas if the device 1, 1′ does not detect the reception of a response signal Sc from the at least one sensor (for the predetermined time TR), the value of the power Pi of the previously emitted activation signal then becomes (step S3) the new value of the maximum power Pmax and the value of the parameter Pmax is modified for the next transmission of an activation signal Si intended for the sensor 9.

Following the modification of one of the values of the parameters Pmin or Pmax, in particular during steps S2 or S3, the difference δ between the values of the minimum and maximum powers Pmin or Pmax is then calculated (step S4). More particularly, the difference δ=Pₘᵢₙ−Pₘₐₓ.

There is then a comparison (step S5) of the difference δ thus calculated with the predetermined value δ₀ of this difference (or target value of the difference). If the calculated value δ is greater than the predetermined value δ_{θ}, a new iteration of steps S1 and S2 or S1 and S3 is implemented. Thus, a new activation signal Si is emitted at the power Pi, accounting for the modified value of one of the minimum power Pmin or maximum power Pmax according to whether step S2 or S3 was implemented during the previous iteration. The determination of said powers Pmax and Pmin is thus performed by means of a dichotomous variation of the power Pi of the activation signal Si, because there is iteration by varying the powers Pi of the activation signal Si the variation of the powers being according to an arithmetic mean of the minimum power Pmin and maximum power Pmax.

More particularly, there is then iteration of the actions performed during steps S1 to S5 described hereinabove until the calculated value of the difference δ is less than or equal to the predetermined value δ_{θ}. When this condition is fulfilled, the values of the minimum power Pmin and maximum power Pmax correspond to the optimal values sought and are then stored in memory during a step Smem.

In an alternative embodiment of the method of FIG. 4, in particular when there are several sensors, for example in the case of dual wheels, there is calibration of the transmission power of the activation signal for each of the sensors, which are generally located at different spatial positions. This means that, in addition to its identifier, a value of the maximum power Pmax and a value of the minimum power Pmin, as well as a predetermined value do, are advantageously associated with each sensor.

Furthermore, each sensor having a specific identifier, there is advantageously association of a spatial position (for example, position n°1 for the closest sensor, position n°2 for the second-closest sensor, etc.) with a sensor (and its identifier). The association of a sensor (and its identifier) with a position is for example determined according to the (reception) power of the response signal Sc emitted in response to the reception of an activation signal.

Thus, unlike the method 100, there is reception or not of the set of response signals emitted by the different sensors, each response signal carrying the identifier of the sensor that emitted it in response to the reception of an activation signal emitted by the activation device 1, 1′, and an update accordingly of the values of the maximum power Pmax and minimum power Pmin.

This means that for a given power Pi of an activation signal, there is an update of the value of the maximum non-activation power Pmax when the sensor has not emitted a response signal within a predefined response time TR, whereas if a response signal is received, there is an update of the value of the minimum activation power Pmin.

There is iteration of the different steps of the method 100, therefore transmission of activation signals while the set of values of the maximum power Pmax and minimum power Pmin (for each of the sensors) have not been determined such that the difference of said powers Pmax and Pmin is less than or equal to the predetermined value do (for each of the sensors).

Thus, for each of the sensors, there is successive determination of the activation or non-activation of each of the sensors according to the reception or not of a signal (carrying the identifier or identification number) from the sensor that emitted it, at activation signal Pi (and the successive activation signal transmission iterations).

Once the difference δ between the maximum power Pmax and minimum power Pmin less than or equal to a predetermined value do is attained for a given sensor, the transmission power values are stored in memory and the sensor is no longer taken into account for the next activation signal transmission iterations. This is until the set of differences 8 between the maximum power Pmax and minimum powers Pmin is less than or equal to a predetermined value do for each of the sensors is determined.

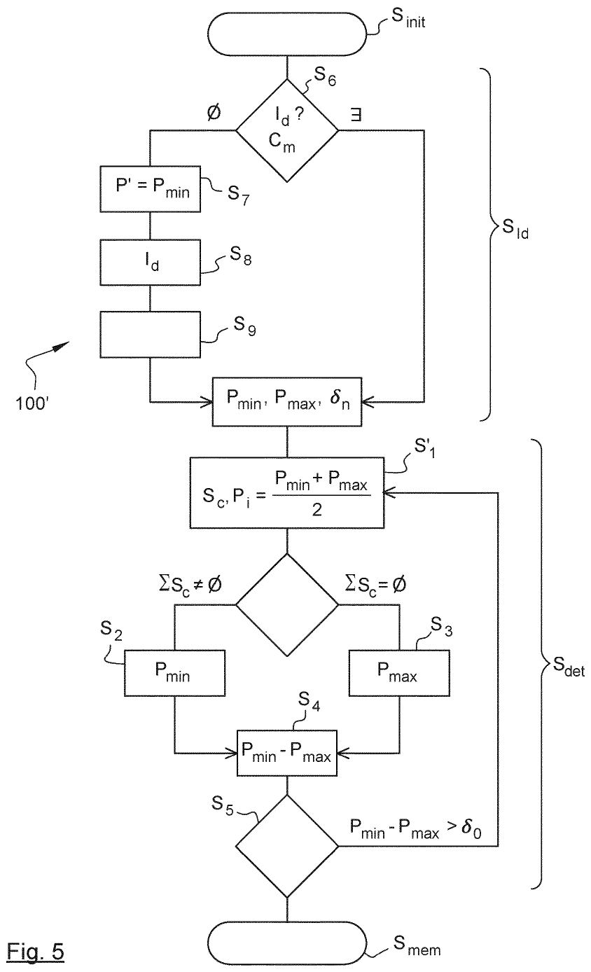

FIG. 5, for its part, is a flow chart of an alternative embodiment of the method of FIG. 4. The method 100′ of FIG. 5 has substantially the same steps as the method of FIG. 4 and these will not necessarily be described again or exhaustively, except to specify the differences or specificities thereof. Moreover, when the steps are analogous or similar, the same references will be used.

Thus, unlike the method 100, the method 100′ of FIG. 5 comprises after the initialisation Sinit, a detection Sid of the sensors to be activated. Indeed, the method according to the invention is also intended for the calibration of an activation signal for a plurality of sensors Cm. As said sensors can be located at different distances from the device 1, 1′, it is necessary to find an activation signal of an adapted power for nominal and standard operating conditions of the activation device.

For this, there is prior identification of a plurality of sensors for which it is sought to calibrate an activation signal. There is thus, after initialisation Sinit, a verification (step S6) of the presence in memory of the identification numbers (or identifiers) Id associated with each of said sensors.

If no sensor identifier is stored in memory, there is then transmission (step S7) of a so-called identification activation signal of a power Pi, for example at the maximum possible transmission power at which the activation device is capable of emitting a signal.

Then, for a predetermined time, for example TR, there is reception (step S8) of the response signals emitted by said sensors. The response signals carrying the identification numbers (or identifiers) of the sensors, there is then storage (step S9) in memory of the identification number (or identifier) of each of the sensors having emitted a response signal to said identification activation signal.

Then, there is determination Sdet of the maximum power Pmax of the non-activation signal of the sensors and the minimum power Pmin of the activation signal of the sensors. Unlike the method 100 of FIG. 4, after transmission of an activation signal at a power Pi:
if a response signal Sc is received from the set of sensors stored in memory, the value of the power Pi of the previously emitted activation signal then becomes (step S2) the new minimum power value Pmin and the value of the parameter Pmin is modified for the next transmission of an activation signal Si;
if a response signal Sc is not received from the set of sensors stored in memory (for a predetermined time TR), the value of the power Pi of the previously emitted activation signal then becomes (step S3) the new maximum power value Pmax and the value of the parameter Pmax is modified for the next transmission of an activation signal Si.

Subsequently and like before, the difference δ between the minimum power Pmin and maximum power Pmax is calculated (step S4) and is compared (step S5) with the predetermined value δ_{θ}.

If the calculated value of the difference δ is greater than the predetermined value do, a new iteration of steps S1′ and S2 or S1′ and S3 is implemented. Thus, a new activation signal Si of power Pi is emitted, but accounting for the modified value of one of the minimum power Pmin or maximum power Pmax.

Otherwise, i.e. when the difference δ of the powers is equal to or less than the predetermined value δ_{θ}, the determination of the transmission powers is stopped, and the values of said maximum power Pmax and minimum power Pmin are saved in a memory (step Smem), for example a random access or read only memory of the electronic entity 35. This is in particular so that the value of the minimum power Pmin is used under nominal conditions of use of the device 1 or 1′ to activate the sensors.

It will be noted that in an alternative embodiment of the method 100′, the identification numbers can be entered manually, or be sorted manually by the user after transmission of an identification signal and reception of the response signals.

In another alternative embodiment not shown of the methods 100 and 100′, the activation signal used during normal conditions of use of the device 1 or 1′ has a transmission power corresponding to the minimum power Pmin stored in memory increased by a predefined percentage, for example by 10%, in order to ensure the activation of the sensor(s).

1. A method for automatically calibrating a power (Pi) of an activation signal (Si) of at least one pressure sensor for a tyre pressure monitoring system (7) of a motor vehicle, said at least one pressure sensor having an identification number and comprising at least one data transmission and receiving module, said method comprising:
determining (Sdet) of a maximum transmission power Pₘₐₓ of a non-activation signal of said at least one pressure sensor and a minimum transmission power Pₘᵢₙ of the activation signal of said at least one pressure sensor;
storing (Smem) in memory of said maximum transmission power Pₘₐₓ and said minimum transmission power Pₘᵢₙ, when a difference δ between said maximum transmission power Pₘₐₓ and said minimum transmission power Pₘᵢₙ attains a value equal to or less than a predetermined value δ_{θ}.

2. The method according to claim 1, wherein the determining (Sdet) of the maximum transmission power Pₘₐₓ and the minimum transmission power Pₘᵢₙ is stopped when the difference δ between said maximum transmission power Pₘₐₓ and the minimum transmission power Pmin attains a value equal to or less than the predetermined value δ_{θ}.

3. The method according to the claim 2, wherein the determination (Sdet) of said maximum transmission power Pₘₐₓ and the minimum transmission power Pₘᵢₙ is performed by a dichotomous variation of the power (Pi) of the activation signal (Si).

4. The method according to claim 1, wherein the determining (Sdet) of said maximum transmission power Pₘₐₓ and the minimum transmission power Pₘᵢₙ is performed by a detection or non-detection of at least one response signal (Sc) from said at least one pressure sensor according to the activation signal (Si) previously emitted at the power Pᵢ.

5. The method according to claim 4, wherein if the at least one response signal (Sc) is received from said at least one pressure sensor then the power Pi of the activation signal (Si) having activated said at least one pressure sensor is identified with the minimum transmission power Pₘᵢₙ.

6. The method according to claim 4, wherein if the at least one response signal (Sc) is not received from said at least one sensor then the power Pᵢ of the activation signal (Si) emitted is identified with the maximum transmission power Pₘₐₓ.

7. The method according to claim 1, further comprising an initialization (Sinit) of said method, wherein initial values of the maximum transmission power Pₘₐₓ of the non-activation signal, the minimum transmission power Pₘᵢₙ of the activation signal (Si) and the difference do between said maximum transmission power Pₘₐₓ and the minimum transmission power Pₘᵢₙ are predetermined.

8. The method according to claim 1, wherein the power Pᵢ of the activation signal (Si) emitted corresponds to an arithmetic mean of the maximum transmission power Pₘₐₓ and the minimum transmission power Pₘᵢₙ.

9. The method according to claim 1, further comprising identification of said at least one pressure sensor by transmission (S7) of an identification activation signal at the power Pi prior to the determining of the maximum transmission power Pmax and the minimum transmission power Pₘᵢₙ.

10. The method according to claim 9, further comprising storing (S9) in memory of the identification number (Id) of each of the at least one pressure sensor having emitted a response signal in response to said identification activation signal.

11. The method according to claim 1, further comprising manually storing in memory of the identification number of each of the at least one sensor prior to the determining of the maximum transmission power Pₘₐₓ and the minimum transmission power Pₘᵢₙ.

12. A device for activating at least one pressure sensor for a tyre pressure monitoring system of a motor vehicle, said device comprising:
at least one sensor activation module;
a module configured for receiving signals transmitted from the at least one pressure sensor;
an electronic entity configured to at least one of store or process information conveyed by the signals transmitted by said at least one pressure sensor; and
a module configured for communicating with a remote electronic entity of the motor vehicle, in order to transmit the information conveyed by the signals received,
wherein said device is configured to determine a maximum transmission power Pₘₐₓ of a non-activation signal of said at least one sensor and a minimum transmission power Pₘᵢₙ of a signal resulting in the activation of said at least one sensor,
wherein said device is configured to stop the determination of said maximum transmission power Pₘₐₓ and minimum transmission power Pₘᵢₙ when a difference δ between said maximum transmission power Pₘₐₓ and the minimum transmission power Pₘᵢₙ attains a value equal to or less than a predetermined value δ_{θ}.

13. The method according to claim 3, wherein the determining (Sdet) of said maximum power transmission Pₘₐₓ and the minimum power transmission Pₘᵢₙ is performed by a detection or non-detection of at least one response signal (Sc) from said at least one pressure sensor according to the activation signal (Si) previously emitted at a power Pᵢ.

14. The method according to claim 5, wherein if the at least one response signal (Sc) is not received from said at least one sensor then the power Pᵢ of the activation signal (Si) emitted is identified with the maximum transmission power Pₘₐₓ.

15. The method according to claim 4, further comprising an initialization (Sinit) of said method, wherein initial values of the maximum transmission power Pₘₐₓ of the non-activation signal, the minimum transmission power Pₘᵢₙ of the activation signal (Si) and the difference δ between said maximum transmission power Pₘₐₓ and the minimum transmission power Pₘᵢₙ are predetermined.

16. The method according to claim 4, wherein the power Pᵢ of the activation signal (Si) emitted corresponds to an arithmetic mean of the maximum transmission power Pₘₐₓ and the minimum transmission power Pₘᵢₙ.

17. The method according to claim 4, further comprising identification of said at least one pressure sensor by transmission (S7) of the activation signal (Si) at the power Pi prior to the determining of the maximum transmission power Pₘₐₓ and the minimum transmission power Pₘᵢₙ.

18. The method of claim 9, wherein the power Pi of the activation signal for the prior identification of said at least one pressure sensor is at a maximum transmission power of a device configured to activate the at least one pressure sensor.
